(19) United States
(12) Patent Application Publication
(10) Pub. No.: US 2026/0361596 A1
(43) Pub. Date: Nov. 12, 2026

(54) GENERATING NETWORK IMPACT VALUES OF ALERTS ASSOCIATED WITH NETWORK RESOURCES

(71) Applicant: Juniper Networks, Inc., Sunnyvale, CA (US)

(72) Inventors: Harsha LAKSHMIKANTH, Bangalore (IN); Per Anders BERGSTEN, Gammelstad (SE); Vijay Kumar GADDE, Bangalore (IN); Sri Ram SANKAR, Bangalore (IN)

(21) Appl. No.: 19/201,235

(22) Filed: May 7, 2025

(51) Int. Cl. H04L 41/069; H04L 41/0681; H04L 41/0686

(52) U.S. Cl. CPC H04L 41/069; H04L 41/0681; H04L 41/0686

(57) ABSTRACT

A device may receive current fault state data associated with a network and a redundancy model associated with the network, and may receive telemetry data and network device alerts associated with a plurality of network devices of the network. The device may generate telemetry alerts based on the telemetry data and to generate a plurality of alerts when combined with the network device alerts, and may calculate an impact value for each of the plurality of alerts, based on the current fault state data and the redundancy model, to generate a plurality of impact values. The device may manage the network based on the plurality of impact values.

### BACKGROUND

Network device alarms and network device key performance indicator (KPI) health are used to track the health of network devices provided in a network.

### SUMMARY

Some implementations described herein relate to a method. The method may include receiving current fault state data associated with a network and a redundancy model associated with the network, and receiving telemetry data and network device alerts associated with a plurality of network devices of the network. The method may include generating telemetry alerts based on the telemetry data and to generate a plurality of alerts when combined with the network device alerts, and calculating an impact value for each of the plurality of alerts, based on the current fault state data and the redundancy model, to generate a plurality of impact values. The method may include managing the network based on the plurality of impact values.

Some implementations described herein relate to a device. The device may include one or more memories and one or more processors. The one or more processors may be configured to receive current fault state data associated with a network and a redundancy model associated with the network, and receive telemetry data and network device alerts associated with a plurality of network devices of the network. The one or more processors may be configured to generate telemetry alerts based on the telemetry data and to generate a plurality of alerts when combined with the network device alerts, and calculate an impact value for each of the plurality of alerts, based on the current fault state data and the redundancy model, to generate a plurality of impact values. The one or more processors may be configured to manage the network based on the plurality of impact values, and provide for display a respective alert associated with one of the plurality of impact values based on determining that the one of the plurality of impact values satisfies the impact threshold.

Some implementations described herein relate to a non-transitory computer-readable medium that stores a set of instructions. The set of instructions, when executed by one or more processors of a device, may cause the device to receive current fault state data associated with a network and a redundancy model associated with the network, wherein the redundancy model specifies a maximum quantity of network events that can occur without affecting operation of the network. The set of instructions, when executed by one or more processors of the device, may cause the device to receive telemetry data and network device alerts associated with a plurality of network devices of the network, and generate telemetry alerts based on the telemetry data and to generate a plurality of alerts when combined with the network device alerts. The set of instructions, when executed by one or more processors of the device, may cause the device to calculate an impact value for each of the plurality of alerts, based on the current fault state data and the redundancy model, to generate a plurality of impact values, and manage the network based on the plurality of impact values.

### BRIEF DESCRIPTION OF THE DRAWINGS

FIGS. 1A-1I are diagrams of an example associated with generating network impact values of alerts associated with network resources.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for generating network impact values of alerts associated with network resources.

### DETAILED DESCRIPTION

The following detailed description of example implementations refers to the accompanying drawings. The same reference numbers in different drawings may identify the same or similar elements.

Current systems may map severities of alarms and alerts to categories, such as critical, major, and minor. While the severities of alarms and alerts can change over time, current systems consider the severities of alarms and alerts in isolation and not based on a state of the network. Thus, from a severity perspective, alarms and alerts are static, isolated, and not indicative of an overall impact to the network. For example, a link failure may generate a corresponding alert. As long as there are redundant links capable of carrying traffic, this link failure can be handled. However, based on an overall network load or available links that are operational, the link failure may result in a catastrophic network failure and hence warrants a critical impact severity. Current systems offer creation of additional rules to generate new alarms based on existing alarms. However, the additional rules fail to work without user customization and are limited to a set of specific rules that have been created. Thus, current techniques for handling network device alarms and alerts consume computing resources (e.g., processing resources, memory resources, communication resources, and/or the like), networking resources, and/or the like associated with failing to define severities for alarms and alerts, handling less severe alarms and alerts based on failing to define the severities for the alarms and alerts, handling a network failure and data loss based on failing to handle more severe alarms and alerts, and/or the like.

Some implementations described herein relate to a controller system for generating network impact values of alerts associated with network resources. For example, a controller system may receive current fault state data associated with a network and a redundancy model associated with the network, and may receive telemetry data and network device alerts associated with a plurality of network devices of the network. The controller system may generate telemetry alerts based on the telemetry data and to generate a plurality of alerts when combined with the network device alerts, and may calculate an impact value for each of the plurality of alerts, based on the current fault state data and the redundancy model, to generate a plurality of impact values. The controller system may manage the network based on the plurality of impact values.

In this way, the controller system may generate network impact values of alerts associated with network resources. For example, a controller system may receive telemetry data, network device alarms associated with network devices of a network, and a current fault state of the network. The controller system may determine telemetry alerts based on the telemetry data, and may convert the network device alarms into network device alerts. The controller system may combine the telemetry alerts and the network device alerts into a plurality of alerts, and may calculate an impact value for each of the plurality of alerts based on the current fault state of the network. The controller system may utilize the impact values to prioritize display of the plurality of alerts to a network operator. Thus, the controller system may conserve computing resources, networking resources, and/or the like that would otherwise have been consumed by failing to define severities for alarms and alerts, handling less severe alarms and alerts based on failing to define the severities for the alarms and alerts, handling a network failure and data loss based on failing to handle more severe alarms and alerts, and/or the like.

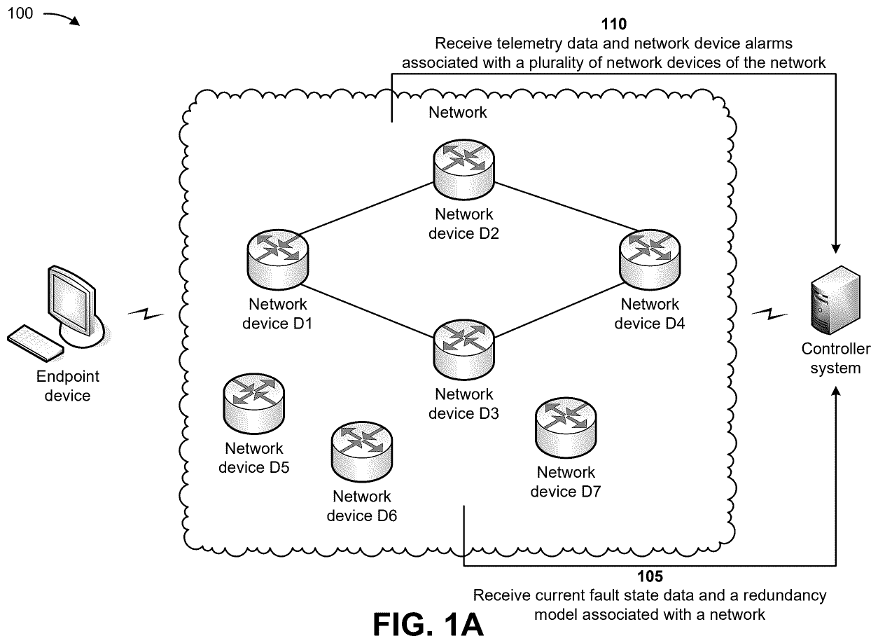

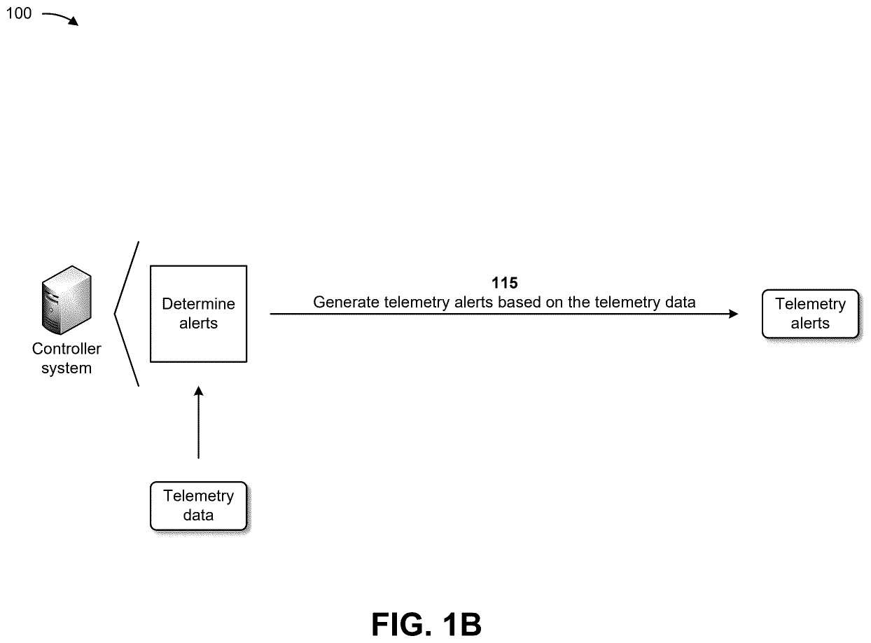

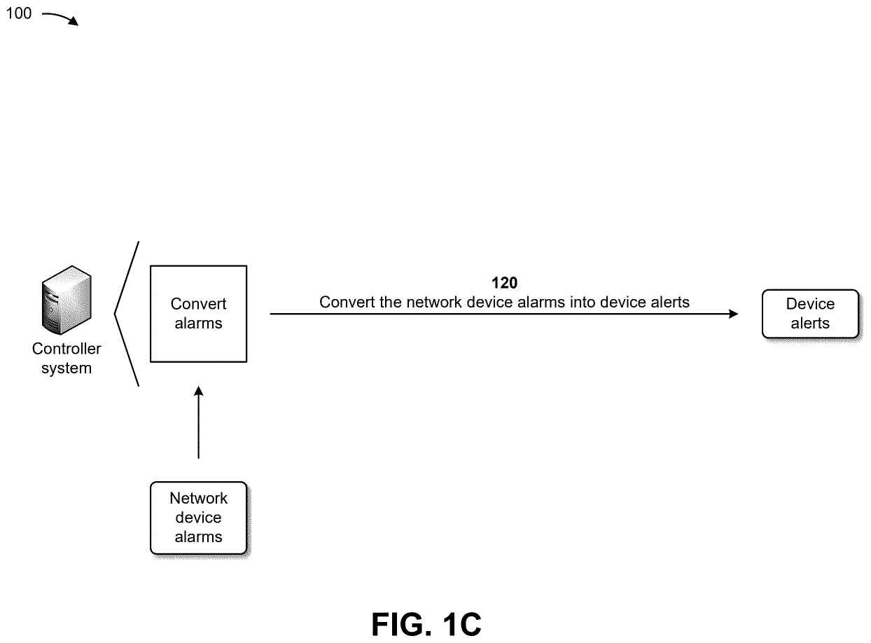

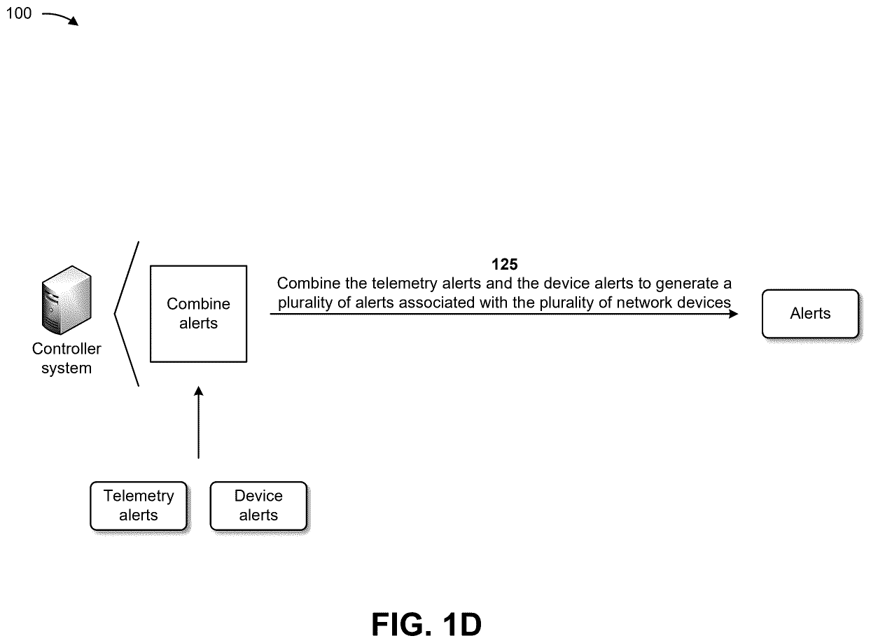

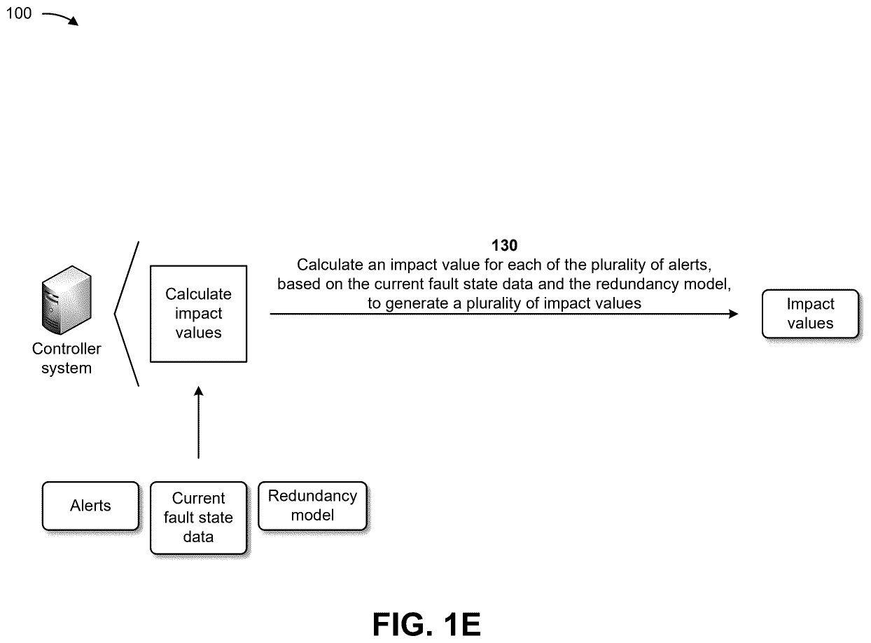

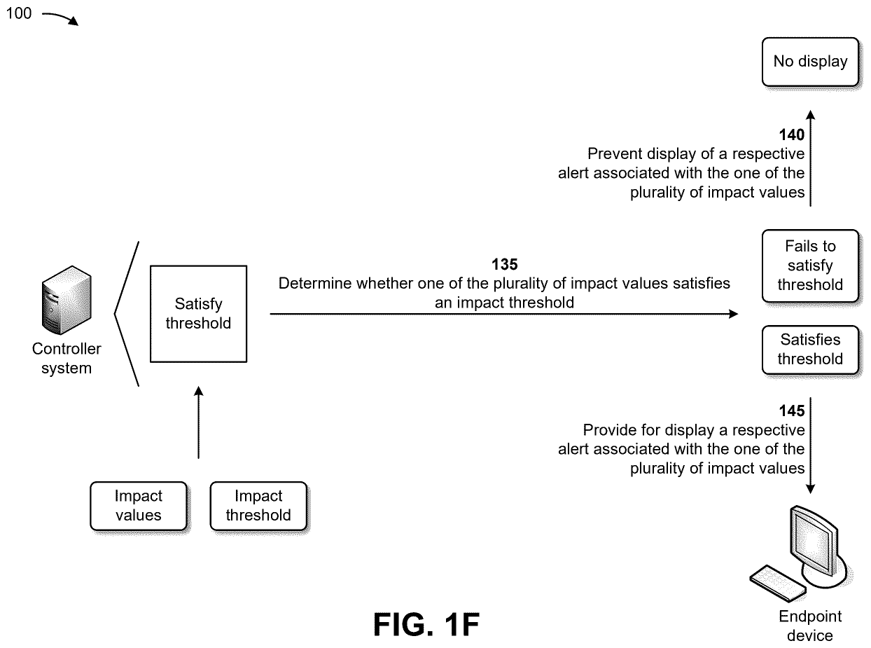

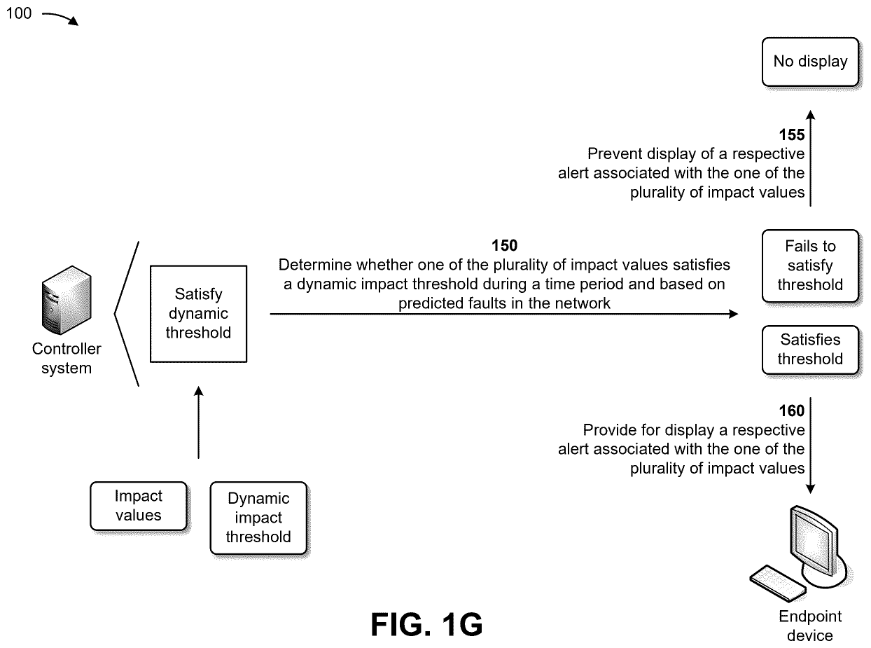

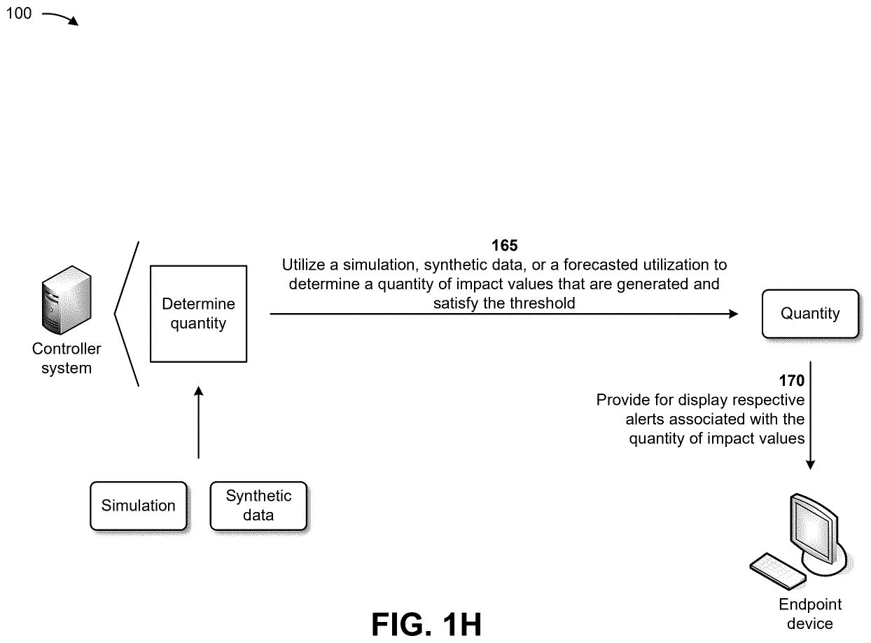

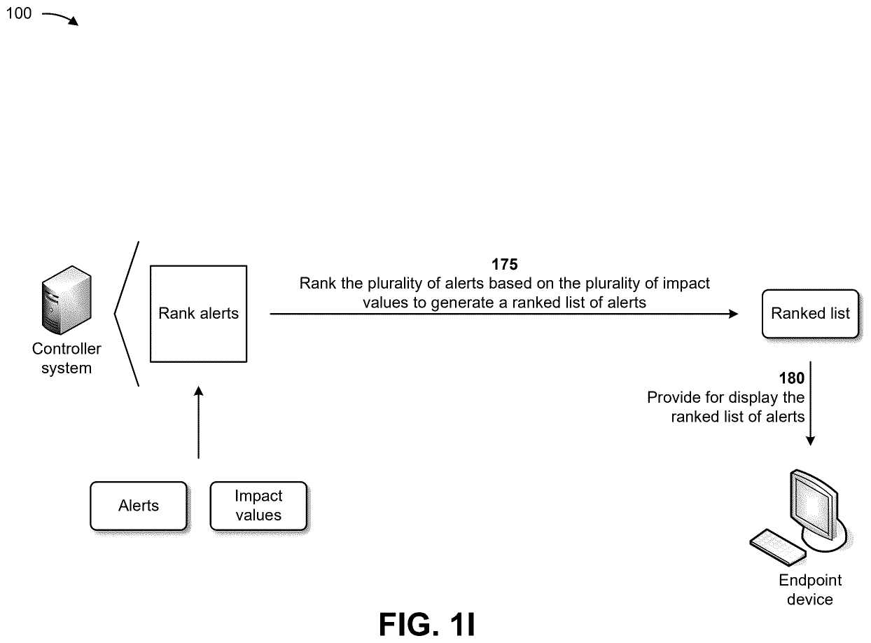

FIGS. 1A-1I are diagrams of an example 100 associated with generating network impact values of alerts associated with network resources. As shown in FIG. 1A, the example 100 includes an endpoint device associated with a network and a controller system. The network may include multiple network devices, such as network device D1, network device D2, network device D3, network device D4, network device D5, network device D6, and network device D7, with links provided between one or more of the network devices. Further details of the endpoint device, the controller system, the network, and the network devices are provided elsewhere herein.

As shown in FIG. 1A, and by reference number 105, the controller system may receive current fault state data associated with the network and a redundancy model associated with the network. For example, the controller system may receive data associated with a state of the network, and may determine the current fault state data based on the received data. The received data may include data identifying operational network devices of the plurality of network devices, operational links associated with the plurality of network devices, current traffic engineering bandwidth allocations for the network, available bandwidth of the network, predicted upcoming traffic patterns (e.g., based on bucketing, trend analysis, or seasonality), scheduled demand based on an event (e.g., a holiday, a sporting event, an entertainment event, etc.), and/or the like. The current fault state data may include a dynamic combination of the received data. In some implementations, the controller system may receive the current fault state date from a subsystem of the controller system, rather than from the network devices of the network.

In some implementations, a user (e.g., a network manager) may define the redundancy model to be used for the network. For example, the redundancy model may include a data center redundancy model with parameters that are defined by the user. The parameters may include a minimum quantity (N) of network devices and/or network resources required to keep the network operational, up and running, and a quantity (e.g., +m) of network devices and/or network resources that may be inoperable without making the network inoperable. The redundancy model may be applied to each service, link, network device, and component (within a network device) of the network, and may include thresholds for each service, link, network device, and component of the network. In some implementations, the redundancy model may include a parameter specifying a maximum quantity of network events that can occur without affecting operation of the network.

In some implementations, the redundancy model may include a 2N redundancy model (e.g., that provides complete duplication of all critical components), a 2N+1 redundancy model (e.g., that is an extension of the 2N model and adds an extra layer of redundancy), an active-passive redundancy model (e.g., one component is active and performing the required tasks, while the other component remains passive and only becomes active in case the primary component fails), an active-active redundancy model (e.g., both components are active and share the load), a geographical redundancy model (e.g., having redundant components located in different geographical locations), a hybrid redundancy model (e.g., combines elements of different redundancy models), and/or the like.

In one example, with current traffic conditions, the network may have four network devices, eight power supplies, and forty links become inoperable while still being able to deliver on network service level agreements (SLAs). Depending on what element becomes inoperable, the inoperable element might make one or more other elements inoperable. For example, a network device becoming inoperable might make eight links and one redundant power supply inoperable. After such an event, the network may include three network devices, seven power supplies, and thirty-two links available. In another example, a power supply becoming inoperable may result in the network having four network devices, seven power supplies, and forty links available.

As further shown in FIG. 1A, and by reference number 110, the controller system may receive telemetry data and network device alarms associated with the plurality of network devices of the network. For example, the controller system may receive telemetry data from telemetry sensors associated with the network devices of the network, the links of the network, components of the network devices, subcomponents of the network devices, and/or the network. The telemetry data may include data that identifies key performance indicators and health of the network devices of the network, the links of the network, components of the network devices, subcomponents of the network devices, and/or the network.

In some implementations, telemetry data may include a wide variety of metrics and information that help in assessing the health, performance, and status of network devices and services. For example, the telemetry data may include network traffic data identifying a volume and type of traffic passing through the network devices. The telemetry data may include latency and response time indicating a time it takes for data to travel from one point in the network to another. The telemetry data may include bandwidth utilization identifying an amount of bandwidth being used by the network devices and the links. The telemetry data may include error rates and packet loss identifying frequency and types of errors occurring in the network. The telemetry data may include device health metrics indicating the operational status and health of the network devices. The telemetry data may include link status and performance identifying the status and performance of the links. The telemetry data may include quality of service (QoS) metrics related to performance of QoS policies and configurations. The telemetry data may include security metrics related to a security status of the network. The telemetry data may include network topology data about the layout and structure of the network.

In some implementations, the controller system may receive the network device alarms from the network devices. The network device alarms may include alarms that provide alerts about conditions of the network devices (e.g., of network interfaces of the network devices, on device chassis of the network devices, in system software of the network devices, and/or the like) that might prevent the network devices from operating normally. In some implementations, from the controller system perspective, the network device alarms may be treated as alerts (e.g., raised by the network devices rather than by the controller system).

As shown in FIG. 1B, and by reference number 115, the controller system may generate telemetry alerts based on the telemetry data. For example, the controller system may utilize multiple steps to generate the telemetry alerts based on the telemetry data. In some implementations, the controller system may process the raw telemetry data to make the telemetry data suitable for analysis. For example, the controller system may utilize normalization to convert the telemetry data from different sources into a common format, may utilize filtering to remove, from the telemetry data, irrelevant or redundant data to focus on key metrics, and/or utilize aggregation to summarize telemetry data over specific time intervals.

Alternatively, or additionally, the controller system may analyze the processed telemetry data to identify patterns, trends, and anomalies. For example, the controller system may define key performance indicators (KPIs) that identify critical metrics that reflect the health and performance of the network (e.g., latency, packet loss, and bandwidth utilization). The controller system may establish threshold values for each KPI that indicate normal and abnormal conditions (e.g., processor usage >80%). The controller system may utilize statistical methods and machine learning models to analyze trends and detect deviations from normal behavior. The controller system may implement anomaly detection techniques to identify unusual patterns or spikes in the telemetry data that may indicate potential issues.

Alternatively, or additionally, the controller system may generate the telemetry alerts based on the analysis of telemetry data. For example, the controller system may compare values of KPIs to predefined thresholds. If a KPI exceeds its threshold, the controller system may generate a telemetry alert. The controller system may analyze trends over time to detect gradual changes that may not trigger threshold-based alerts, and may generate telemetry alerts if a significant trend is detected. The controller system may utilize anomaly detection models to identify unusual patterns in the telemetry data, and may generate telemetry alerts when anomalies are detected.

As shown in FIG. 1C, and by reference number 120, the controller system may convert the network device alarms into device alerts. For example, the controller system may perform several steps to convert the network device alarms into the device alerts. In some implementations, the controller system may utilize data normalization to convert the network device alarms into a common format for consistent processing. For example, the controller system may convert alarms from different network devices and formats into a standardized format, and may normalize data fields to ensure consistency (e.g., convert timestamps to a common time zone and format, standardize severity levels, and unify device identifiers). In some implementations, the controller system may categorize the normalized alarms based on predefined criteria to facilitate alert generation. For example, the controller system may classify alarms based on their severity levels (e.g., hardware failure alarms may be classified as critical, while configuration warnings may be classified as minor), and may classify alarms based on their types (e.g., alarms related to link status changes, hardware failures, configuration errors, and performance issues). The controller system may associate alarms with specific network devices to facilitate targeted alert generation. In some implementations, the controller system may generate the device alerts based on the categorized alarms using threshold-based alerting. For example, the controller system may establish thresholds for different types of alarms (e.g., a threshold for link status changes might be set to generate an alert if a link goes down). The controller system may continuously compare the severity and type of each alarm to the predefined thresholds. If an alarm exceeds its threshold, the controller system may generate a corresponding device alert.

As shown in FIG. 1D, and by reference number 125, the controller system may combine the telemetry alerts and the device alerts to generate a plurality of alerts associated with the plurality of network devices. For example, combining the telemetry alerts and the device alerts may include integrating data from different sources to provide a comprehensive view of the network's health and performance. The combined alerts may ensure that the alerts are contextualized, prioritized, and actionable. In some implementations, the controller system may correlate related telemetry alerts and device alerts to generate the plurality of alerts associated with the plurality of network devices. For example, the controller system may utilize correlation models to identify related telemetry alerts and device alerts (e.g., a high processor usage (e.g., a telemetry alert) and a hardware failure (e.g., a device alert) on the same network device may be related. In some implementations, the controller system may combine a related telemetry alert and device alert into a single, comprehensive alert. This may include merging the information from both types of alerts to provide a complete picture of an issue. The controller system may add context to the combined alerts by including relevant information from both the telemetry data and the device alarms. For example, a combined alert may include details about high processor usage, hardware failure, and the impact on network performance. In this way, the controller system may effectively combine telemetry alerts and device alerts, providing a comprehensive view of network issues and ensuring timely response and resolution.

As shown in FIG. 1E, and by reference number 130, the controller system may calculate an impact value for each of the plurality of alerts, based on the current fault state data and the redundancy model, to generate a plurality of impact values. For example, calculating an impact value for each alert involves assessing a potential effect of the alert on the network's overall performance and reliability. The controller system may utilize the current fault state data and the redundancy model to determine a criticality of each alert. In some implementations, the controller system may analyze each alert to understand a nature and a context of the alert. For example, the controller system may determine a type of alert (e.g., hardware failure, high processor usage, or link down) based on the analysis, and may identify which network devices, links, or services are affected by the alert. The controller system may evaluate the severity of the alert (e.g., critical, major, or minor) based on predefined criteria or thresholds.

In some implementations, the controller system may apply the redundancy model to understand the network's ability to tolerate a fault or an event indicated by the alert. For example, the controller system may determine the current redundancy levels for affected components (e.g., check if there are backup network devices or links available). The controller system may assess whether the network can continue to operate normally despite the fault. For example, if a link is inoperable, the controller system may check if there are redundant links that can handle traffic. In some implementations, the controller system may calculate the impact value for each alert based on utilizing the current fault state data and applying the redundancy model. For example, the controller system may assess how the alert affects the network's operations (e.g., an operational impact). For example, a critical router failure might have a higher operational impact than a minor switch failure. The controller system may consider the impact on specific services or applications (e.g., a service impact). For example, if the alert affects a network device critical to a high-priority service, the impact value may be higher. The controller system may factor in the redundancy model to determine how the fault affects the network's redundancy (e.g., a redundancy impact). For example, if the alert reduces the redundancy below acceptable levels, the impact value may be higher. In some implementations, the controller system may utilize a weighted formula to combine the operational impact, the service impact, and the redundancy impact into a single impact value, as follows: Impact value=(Wₒ×Operational impact)+(Wₛ×Service impact)+(Wᵣ×Redundancy impact) where Wₒ, Wₛ, and Wᵣ are weights assigned to each impact based on their importance.

As shown in FIG. 1F, and by reference number 135, the controller system may determine whether one of the plurality of impact values satisfies an impact threshold. For example, a user of the controller system may define the impact threshold. When an impact value satisfies the impact threshold, the controller system may provide, to the user, a notification indicating that the alert associated with the impact value may cause network issues and should be addressed. In some implementations, the controller system may determine that the one of the plurality of impact values satisfies the impact threshold. Alternatively, the controller system may determine that the one of the plurality of impact values fails to satisfy the impact threshold. In some implementations, in the absence of an impact threshold, the controller system may default to identifying an impact value as being high impact when a fault associated with the impact value is one fault away from network failure.

As further shown in FIG. 1F, and by reference number 140, the controller system may prevent display of a respective alert associated with the one of the plurality of impact values based on determining that the one of the plurality of impact values fails to satisfy the impact threshold. For example, if the controller system determines that the one of the plurality of impact values fails to satisfy the impact threshold, the controller system may prevent display of the respective alert associated with the one of the plurality of impact values. In this way, a user (e.g., a network operator) may not be inundated with alerts with low impact values (e.g., associated with faults that will not affect the network).

As further shown in FIG. 1F, and by reference number 145, the controller system may provide for display a respective alert associated with the one of the plurality of impact values based on determining that the one of the plurality of impact values satisfies the impact threshold. For example, if the controller system determines that the one of the plurality of impact values satisfies the impact threshold, the controller system may provide data identifying the respective alert associated with the one of the plurality of impact values to the endpoint device. The endpoint device may display the respective alert associated with the one of the plurality of impact values to a user of the endpoint device. In this way, the user (e.g., a network operator) may be quickly made aware of alerts with high impact values (e.g., associated with faults that will harm the network) so that the user may attempt to correct the faults.

As shown in FIG. 1G, and by reference number 150, the controller system may determine whether one of the plurality of impact values satisfies a dynamic impact threshold during a time period and based on predicted faults in the network. For example, the controller system may utilize a machine learning model to perform a look-forward forecast of resource utilization for the network and to predict how many faults typically happen in a given time period (e.g., one day) in the network. The controller system may utilize the forecast of the resource utilization and the predicted faults to generate the dynamic impact threshold. In some implementations, the dynamic impact threshold may be set so that the network maintains redundant pool numbers that are higher than what is projected to be depleted during the time period. In some implementations, the controller system may determine that the one of the plurality of impact values satisfies the dynamic impact threshold. Alternatively, the controller system may determine that the one of the plurality of impact values fails to satisfy the dynamic impact threshold.

As further shown in FIG. 1G, and by reference number 155, the controller system may prevent display of a respective alert associated with the one of the plurality of impact values based on determining that the one of the plurality of impact values fails to satisfy the dynamic impact threshold. For example, if the controller system determines that the one of the plurality of impact values fails to satisfy the dynamic impact threshold, the controller system may prevent display of the respective alert associated with the one of the plurality of impact values. In this way, a user (e.g., a network operator) may not be inundated with alerts with low impact values (e.g., associated with faults that will not affect the network).

As further shown in FIG. 1G, and by reference number 160, the controller system may provide for display a respective alert associated with the one of the plurality of impact values based on determining that the one of the plurality of impact values satisfies the dynamic impact threshold. For example, if the controller system determines that the one of the plurality of impact values satisfies the dynamic impact threshold, the controller system may provide data identifying the respective alert associated with the one of the plurality of impact values to the endpoint device. The endpoint device may display the respective alert associated with the one of the plurality of impact values to a user of the endpoint device. In this way, the user (e.g., a network operator) may be quickly made aware of alerts with high impact values (e.g., associated with faults that will harm the network) so that the user may attempt to correct the faults.

As shown in FIG. 1H, and by reference number 165, the controller system may utilize a simulation, synthetic data, or a forecasted utilization to determine a quantity of impact values that are generated and satisfy the impact threshold. For example, the controller system may utilize a machine learning model to perform a look-forward forecast of resource utilization for the network and to determine how many faults typically happen in a given time period (e.g., one day) in the network. The controller system may utilize the forecast of the resource utilization and the determined faults to determine the quantity of impact values that are generated and satisfy the impact thresholds.

In some implementations, the controller system may utilize synthetic data (e.g., traffic) to monitor the end-services provided by the network. The controller system may utilize the monitored end-services during utilization of the synthetic data to determine the quantity of impact values that are generated and satisfy the impact thresholds. Alternatively, or additionally, the controller system may utilize simulation to simulate a loss of any resource and a net impact in terms of alerts generated based on the loss. The simulation may include the impact values, and may identify a resource or resources, which when made inoperable in the simulation, would result in impact alerts being generated and satisfying the impact thresholds.

As further shown in FIG. 1H, and by reference number 170, the controller system may provide for display respective alerts associated with the quantity of impact values. For example, the controller system may provide data identifying the respective alert associated with the one of the plurality of impact values to the endpoint device. The endpoint device may display the respective alert associated with the one of the plurality of impact values to a user (e.g., a network administrator) of the endpoint device.

As shown in FIG. 1I, and by reference number 175, the controller system may rank the plurality of alerts based on the plurality of impact values to generate a ranked list of alerts. For example, the controller system may rank one of the plurality of alerts with a greatest impact value first in the ranked list of alerts, may rank one of the plurality of alerts with a next greatest impact value second in the ranked list of alerts, and/or the like. The controller system may continue the ranking until the one of the plurality of alerts with a smallest impact value is ranked last in the ranked list of alerts.

As further shown in FIG. 1I, and by reference number 180, the controller system may provide for display the ranked list of alerts. For example, the controller system may provide the ranked list of alerts to the endpoint device, and the endpoint device may display the ranked list of alerts to a user (e.g., a network operator) of the endpoint device. Alternatively, the controller system may provide a top portion (e.g., a top ten percent, twenty percent, and/or the like) of the ranked list of alerts to the endpoint device, and the endpoint device may display the top portion of the ranked list of alerts to the user. In this way, the user may prioritize handling of the plurality of alerts based on the order provided in the ranked list of alerts.

In this way, the controller system may generate network impact values of alerts associated with network resources. For example, a controller system may receive telemetry data, network device alarms associated with network devices of a network, and a current fault state of the network. The controller system may determine telemetry alerts based on the telemetry data, and may convert the network device alarms into network device alerts. The controller system may combine the telemetry alerts and the network device alerts into a plurality of alerts, and may calculate an impact value for each of the plurality of alerts based on the current fault state of the network. The controller system may utilize the impact values to prioritize display of the plurality of alerts to a network operator. Thus, the controller system may conserve computing resources, networking resources, and/or the like that would otherwise have been consumed by failing to define severities for alarms and alerts, handling less severe alarms and alerts based on failing to define the severities for the alarms and alerts, handling a network failure and data loss based on failing to handle more severe alarms and alerts, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

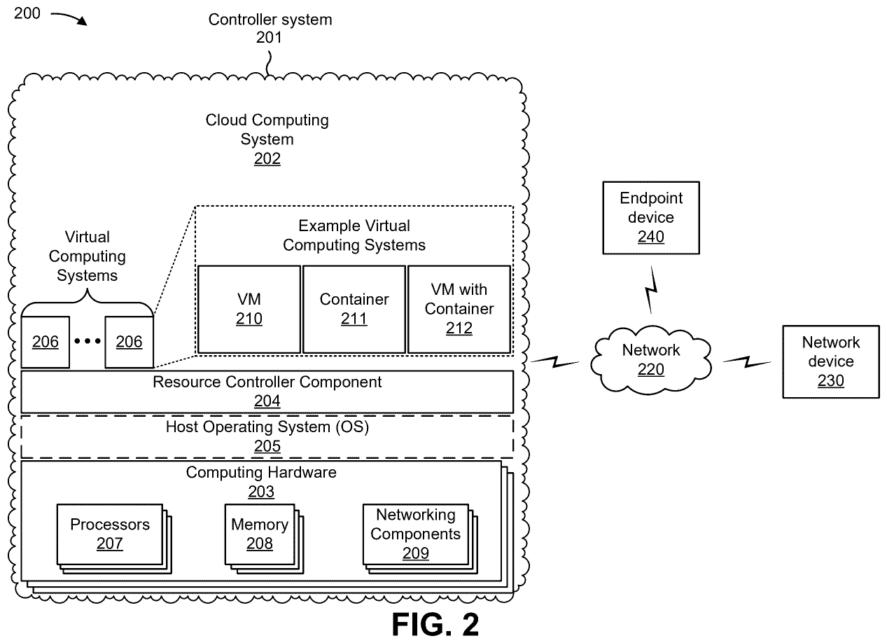

FIG. 2 is a diagram of an example environment 200 in which systems and/or methods described herein may be implemented. As shown in FIG. 2, the environment 200 may include a controller system 201, which may include one or more elements of and/or may execute within a cloud computing system 202. The cloud computing system 202 may include one or more elements 203-212, as described in more detail below. As further shown in FIG. 2, the environment 200 may include a network 220, a network device 230, and/or an endpoint device 240. Devices and/or elements of the environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as the computing hardware 203) capable of virtualizing the computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using the computing hardware 203. As shown, the virtual computing system 206 may include a virtual machine 210, a container 211, or a hybrid environment 212 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

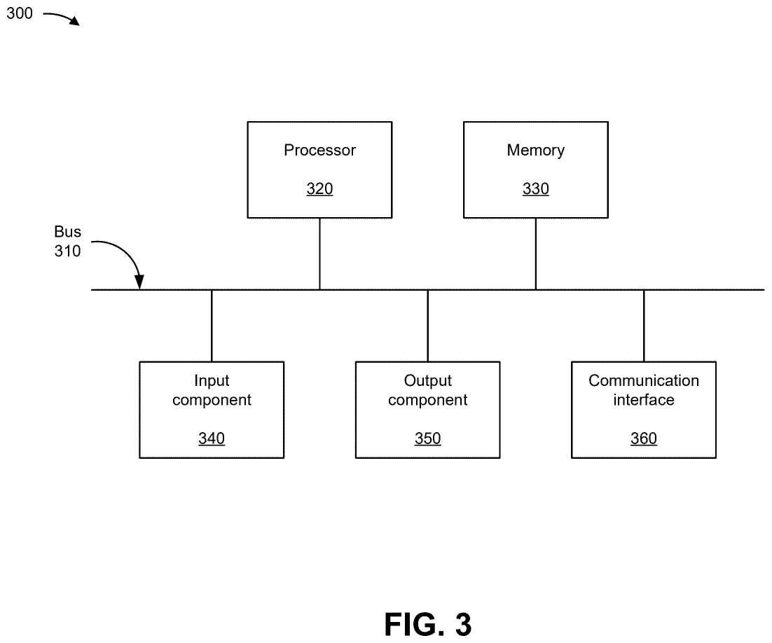

Although the controller system 201 may include one or more elements 203-212 of the cloud computing system 202, may execute within the cloud computing system 202, and/or may be hosted within the cloud computing system 202, in some implementations, the controller system 201 may not be cloud-based (e.g., may be implemented outside of a cloud computing system) or may be partially cloud-based. For example, the controller system 201 may include one or more devices that are not part of the cloud computing system 202, such as a device 300 of FIG. 3, which may include a standalone server or another type of computing device. The controller system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The network device 230 may include one or more devices capable of receiving, processing, storing, routing, and/or providing traffic (e.g., a packet and/or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computing devices of a cloud computing environment or a data center. In some implementations, a group of network devices 230 may be a group of data center nodes that are used to route traffic flow through a network.

The endpoint device 240 may include one or more devices capable of receiving, generating, storing, processing, and/or providing information, as described elsewhere herein. The endpoint device 240 may include a communication device and/or a computing device. For example, the endpoint device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of one or more devices of FIG. 2. The example components may be included in a device 300, which may correspond to the controller system 201, the network device 230, and/or the endpoint device 240. In some implementations, the controller system 201, the network device 230, and/or the endpoint device 240 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

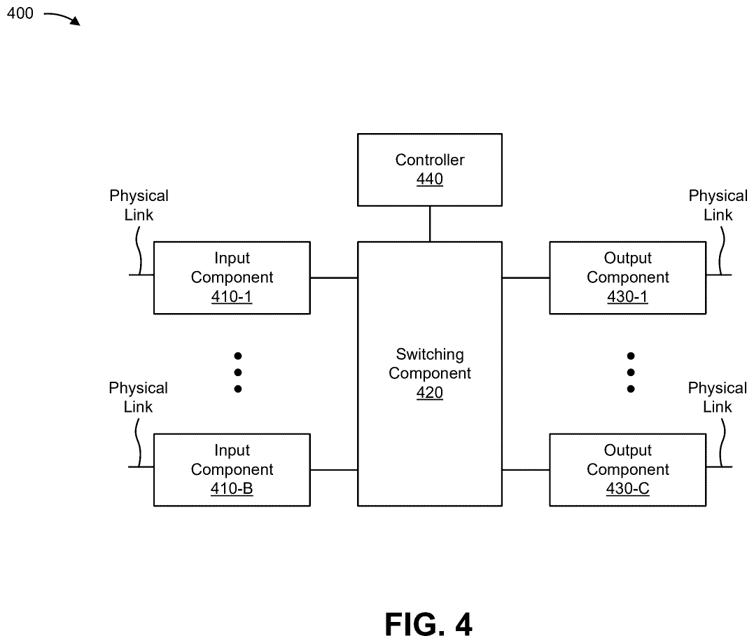

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

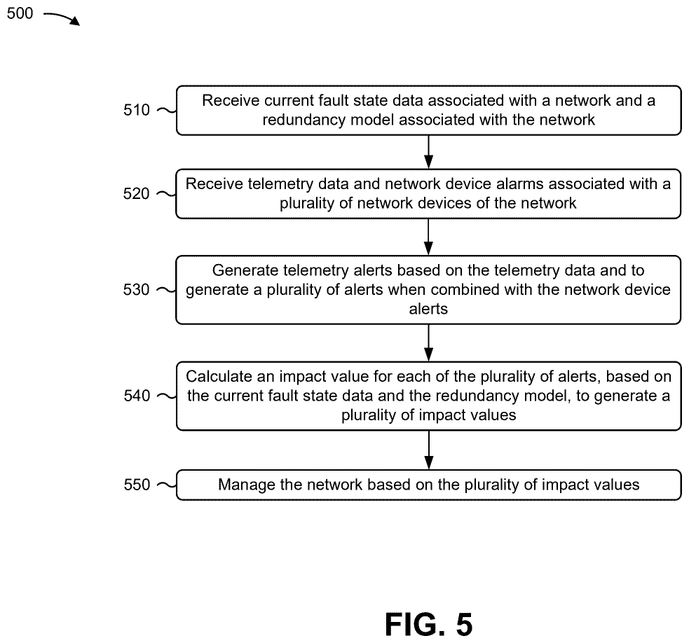

FIG. 5 is a flowchart of an example process 500 for generating network impact values of alerts associated with network resources. In some implementations, one or more process blocks of FIG. 5 may be performed by a device (e.g., the controller system 201). In some implementations, one or more process blocks of FIG. 5 may be performed by another device or a group of devices separate from or including the device, such as an endpoint device (e.g., the endpoint device 240) and/or a network device (e.g., the network device 230). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving current fault state data associated with a network and a redundancy model associated with the network (block 510). For example, the device may receive current fault state data associated with a network and a redundancy model associated with the network, as described above. In some implementations, the current fault state data includes data identifying one or more of operational network devices of the plurality of network devices, operational links associated with the plurality of network devices, current traffic engineering bandwidth allocations for the network, available bandwidth of the network, predicted upcoming traffic patterns, or scheduled demand based on an event. In some implementations, the redundancy model specifies a maximum quantity of network events that can occur without affecting operation of the network.

As further shown in FIG. 5, process 500 may include receiving telemetry data and network device alerts associated with a plurality of network devices of the network (block 520). For example, the device may receive telemetry data and network device alerts associated with a plurality of network devices of the network, as described above.

As further shown in FIG. 5, process 500 may include generating telemetry alerts based on the telemetry data and to generate a plurality of alerts when combined with the network device alerts (block 530). For example, the device may generate telemetry alerts based on the telemetry data and to generate a plurality of alerts when combined with the network device alerts, as described above. In some implementations, generating the telemetry alerts based on the telemetry data includes calculating key performance indicators (KPIs) based on the telemetry data, identifying KPIs, of the calculated KPIs, that fail to satisfy respective KPI thresholds, and generating the telemetry alerts for the KPIs that fail to satisfy the respective KPI thresholds.

As further shown in FIG. 5, process 500 may include calculating an impact value for each of the plurality of alerts, based on the current fault state data and the redundancy model, to generate a plurality of impact values (block 540). For example, the device may calculate an impact value for each of the plurality of alerts, based on the current fault state data and the redundancy model, to generate a plurality of impact values, as described above.

As further shown in FIG. 5, process 500 may include managing the network based on the plurality of impact values (block 550). For example, the device may manage the network based on the plurality of impact values, as described above.

In some implementations, process 500 includes determining whether one of the plurality of impact values satisfies an impact threshold. In some implementations, process 500 includes preventing display of a respective alert associated with the one of the plurality of impact values based on determining that the one of the plurality of impact values fails to satisfy the impact threshold. In some implementations, process 500 includes providing for display a respective alert associated with the one of the plurality of impact values based on determining that the one of the plurality of impact values satisfies the impact threshold.

In some implementations, process 500 includes determining whether one of the plurality of impact values satisfies a dynamic impact threshold during a time period and based on predicted faults in the network. In some implementations, process 500 includes preventing display of a respective alert associated with the one of the plurality of impact values based on determining that the one of the plurality of impact values fails to satisfy the dynamic impact threshold. In some implementations, process 500 includes providing for display a respective alert associated with the one of the plurality of impact values based on determining that the one of the plurality of impact values satisfies the dynamic impact threshold.

In some implementations, process 500 includes utilizing a simulation or synthetic data to determine a quantity of impact values that are generated and satisfy an impact threshold. In some implementations, process 500 includes providing for display respective alerts associated with the quantity of impact values. In some implementations, process 500 includes ranking the plurality of alerts based on the plurality of impact values to generate a ranked list of alerts, and providing for display the ranked list of alerts.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, current fault state data associated with a network and a redundancy model associated with the network;
receiving, by the device, telemetry data and network device alerts associated with a plurality of network devices of the network;
generating, by the device, telemetry alerts based on the telemetry data and to generate a plurality of alerts when combined with the network device alerts;
calculating, by the device, an impact value for each of the plurality of alerts, based on the current fault state data and the redundancy model, to generate a plurality of impact values; and
managing, by the device, the network based on the plurality of impact values.

2. The method of claim 1, further comprising:
determining whether one of the plurality of impact values satisfies an impact threshold.

3. The method of claim 2, further comprising:
preventing display of a respective alert associated with the one of the plurality of impact values based on determining that the one of the plurality of impact values fails to satisfy the impact threshold.

4. The method of claim 2, further comprising:
providing for display a respective alert associated with the one of the plurality of impact values based on determining that the one of the plurality of impact values satisfies the impact threshold.

5. The method of claim 1, further comprising:
determining whether one of the plurality of impact values satisfies a dynamic impact threshold during a time period and based on predicted faults in the network.

6. The method of claim 5, further comprising:
preventing display of a respective alert associated with the one of the plurality of impact values based on determining that the one of the plurality of impact values fails to satisfy the dynamic impact threshold.

7. The method of claim 5, further comprising:
providing for display a respective alert associated with the one of the plurality of impact values based on determining that the one of the plurality of impact values satisfies the dynamic impact threshold.

8. A device, comprising:
one or more memories; and
one or more processors to:
receive current fault state data associated with a network and a redundancy model associated with the network;
receive telemetry data and network device alerts associated with a plurality of network devices of the network;
generate telemetry alerts based on the telemetry data and to generate a plurality of alerts when combined with the network device alerts;
calculate an impact value for each of the plurality of alerts, based on the current fault state data and the redundancy model, to generate a plurality of impact values;
manage the network based on the plurality of impact values; and
provide for display a respective alert associated with one of the plurality of impact values based on determining that the one of the plurality of impact values satisfies an impact threshold.

9. The device of claim 8, wherein the one or more processors are further to:
utilize a simulation or synthetic data to determine a quantity of impact values that are generated and satisfy an impact threshold.

10. The device of claim 9, wherein the one or more processors are further to:
provide for display respective alerts associated with the quantity of impact values.

11. The device of claim 8, wherein the one or more processors are further to:
rank the plurality of alerts based on the plurality of impact values to generate a ranked list of alerts; and
provide for display the ranked list of alerts.

12. The device of claim 8, wherein the current fault state data includes data identifying one or more of operational network devices of the plurality of network devices, operational links associated with the plurality of network devices, current traffic engineering bandwidth allocations for the network, available bandwidth of the network, predicted upcoming traffic patterns, or scheduled demand based on an event.

13. The device of claim 8, wherein the one or more processors, to generate the telemetry alerts based on the telemetry data, are to:
calculate key performance indicators (KPIs) based on the telemetry data;
identify KPIs, of the calculated KPIs, that fail to satisfy respective KPI thresholds; and
generate the telemetry alerts for the KPIs that fail to satisfy the respective KPI thresholds.

14. The device of claim 8, wherein the redundancy model specifies a maximum quantity of network events that can occur without affecting operation of the network.

15. A non-transitory computer-readable medium storing a set of instructions, the set of instructions comprising:
one or more instructions that, when executed by one or more processors of a device, cause the device to:
receive current fault state data associated with a network and a redundancy model associated with the network,
wherein the redundancy model specifies a maximum quantity of network events that can occur without affecting operation of the network;
receive telemetry data and network device alerts associated with a plurality of network devices of the network;
generate telemetry alerts based on the telemetry data and to generate a plurality of alerts when combined with the network device alerts;
calculate an impact value for each of the plurality of alerts, based on the current fault state data and the redundancy model, to generate a plurality of impact values; and
manage the network based on the plurality of impact values.

16. The non-transitory computer-readable medium of claim 15, wherein the one or more instructions further cause the device to:
determine whether one of the plurality of impact values satisfies an impact threshold; and
selectively:
prevent display of a respective alert associated with the one of the plurality of impact values based on determining that the one of the plurality of impact values fails to satisfy the impact threshold, or
provide for display a respective alert associated with the one of the plurality of impact values based on determining that the one of the plurality of impact values satisfies the impact threshold.

17. The non-transitory computer-readable medium of claim 15, wherein the one or more instructions further cause the device to:
determine whether one of the plurality of impact values satisfies a dynamic impact threshold during a time period and based on predicted faults in the network; and
selectively:
prevent display of a respective alert associated with the one of the plurality of impact values based on determining that the one of the plurality of impact values fails to satisfy the dynamic impact threshold, or
provide for display a respective alert associated with the one of the plurality of impact values based on determining that the one of the plurality of impact values satisfies the dynamic impact threshold.

18. The non-transitory computer-readable medium of claim 15, wherein the one or more instructions further cause the device to:
utilize a simulation or synthetic data to determine a quantity of impact values that are generated and satisfy an impact threshold; and
provide for display respective alerts associated with the quantity of impact values.

19. The non-transitory computer-readable medium of claim 15, wherein the one or more instructions further cause the device to:
rank the plurality of alerts based on the plurality of impact values to generate a ranked list of alerts; and
provide for display the ranked list of alerts.

20. The non-transitory computer-readable medium of claim 15, wherein the one or more instructions, that cause the device to generate the telemetry alerts based on the telemetry data, cause the device to:
calculate key performance indicators (KPIs) based on the telemetry data;
identify KPIs, of the calculated KPIs, that fail to satisfy respective KPI thresholds; and
generate the telemetry alerts for the KPIs that fail to satisfy the respective KPI thresholds.
